(19) United States
(12) Patent Application Publication
(10) Pub. No.: US 2025/0165373 A1
(43) Pub. Date: May 22, 2025

(54) SYSTEM FOR CONTROLLING CLOUD RESOURCES

(71) Applicant: Sync Computing Corp., Cambridge, MA (US)

(72) Inventors: Scott Romney, Portland, OR (US); Sahil Singhal, New York, NY (US); Peter Norman Tamisin, Cumming, GA (US)

(21) Appl. No.: 18/949,431

(22) Filed: Nov. 15, 2024

Related U.S. Application Data
(60) Provisional application No. 63/600,613, filed on Nov. 17, 2023.

(51) Int. Cl. G06F 11/34; G06F 9/48

(52) U.S. Cl. CPC G06F 11/3423; G06F 9/4881; G06F 11/3476

(57) ABSTRACT

A method for optimizing a workflow provided by a computing platform to a cloud computing system is described. Metrics for a job of the workflow run on the cloud computing system are received. The job is run on the cloud computing system based on a schedule and a cloud computing infrastructure configuration. An update to the cloud computing infrastructure configuration is generated based on the metrics. The cloud computing infrastructure configuration is automatically updated based on the update, thereby providing an updated cloud computing infrastructure configuration. A next scheduled run of the job on the cloud computing system is based on the updated cloud computing infrastructure configuration.

### CROSS REFERENCE TO OTHER APPLICATIONS

This application claims priority to U.S. Provisional Patent Application No. 63/600,613 entitled SYSTEM FOR CLOSED LOOP CONTROL OF CLOUD RESOURCES filed Nov. 17, 2023 which is incorporated herein by reference for all purposes.

### BACKGROUND OF THE INVENTION

Cloud computing environments are attractive for use for a variety of workflows. For example, machine learning and production data processing may be desired to be performed in such environments. Cloud computing environments offer a wide range of choices with respect to the resources available and the corresponding prices for the resources used for a workflow. The performance (e.g., the runtime for a particular task or the total runtime for a set of tasks) depends upon the resources allocated to the workflow and the scheduling of tasks in the workflow. Thus, cloud computing environments can provide flexibility for different cost-performance needs. However, this flexibility of cloud environments also leads to significant complexity in selecting the configuration of resources and infrastructure (e.g., virtual machine instance type and resource demands) for each task in a cloud computing workflow. In particular, poor (or sub-optimal) selection of resources may result in long run times and/or significant costs incurred for the resources used. Thus, both longer run times and larger costs may be significant issues for users of a cloud computing infrastructure. Further, resource allocation using conventional techniques may be poor and/or may take a significant amount of time to perform. Re-allocating resources between iterations of a recurring task may be particularly challenging. However, cost and runtime inefficiencies compound as a task with sub-optimal selection of resources is repeated. Accordingly, an improved mechanism for provisioning resources for cloud computing environments is desired.

### BRIEF DESCRIPTION OF THE DRAWINGS

Various embodiments of the invention are disclosed in the following detailed description and the accompanying drawings.

FIG. 1 is a block diagram illustrating an embodiment of a system for optimizing a cloud computing infrastructure configuration and the environment in which the system is used.

FIG. 2 is a block diagram illustrating an embodiment of a system for optimizing a cloud computing infrastructure configuration and an environment in which the system is used.

FIGS. 3A-3B are block diagrams illustrating embodiments of systems for optimizing a computing infrastructure configuration and an environment in which the system is used.

FIG. 4 is a flow diagram illustrating an embodiment of a method for optimizing a workflow provided by a cloud computing platform to a cloud computing system.

FIG. 5 is a flow diagram illustrating an embodiment of a method for optimizing a workflow provided by a cloud computing platform to a cloud computing system.

FIG. 6 depicts a graph of an embodiment of estimated cost and a graph of an embodiment of runtime over multiple runs of a job.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method for optimizing a workflow provided by a computing platform to a cloud computing system is described. Metrics for a job of the workflow run on the cloud computing system are received. The job is run on the cloud computing system based on a schedule and a cloud computing infrastructure configuration. An update to the cloud computing infrastructure configuration is generated based on the metrics. The cloud computing infrastructure configuration is automatically updated based on the update, thereby providing an updated cloud computing infrastructure configuration. A next scheduled run of the job on the cloud computing system is based on the updated cloud computing infrastructure configuration.

The metrics may be received in response to a completion of the job. In some such embodiments, the completion of the job is indicated by the cloud computing system. In some embodiments, the metrics are gathered by a task. The task may run within the workflow or outside of the workflow. In various embodiments, the metrics include event logs, specifications of the computing platform, specifications of the cloud computing infrastructure, cost of a run of the job, estimated cost of a run of the job, runtime of a run of the job, estimated runtime of a run of the job, latency of a run of the job, estimated latency of a run of the job, accuracy of a run of a job, and/or any other appropriate metric.

In some embodiments, the generating the update is performed in real time. In some embodiments, real time generation of the update includes generating the update prior to a next scheduled run of the job. In various embodiments, the update may be generated to optimize a job cost, a job runtime, a job latency, and/or any other appropriate aspect(s) of the job. In some such embodiments, the job cost is based on an estimated cost of running the job on the cloud computing system after applying the update. The estimated cost may be calculated based on the metrics and at least one cost associated with the cloud computing system.

In some embodiments, the method includes repeating, for the next scheduled run, the receiving the metrics and the generating the update. The cloud computing infrastructure configuration is automatically updated based on the repeating. Another scheduled run of the job on the cloud computing system is based on the updated cloud computing infrastructure configuration. In some embodiments, the method includes repeating the receiving the metrics and the generating the update for each of a plurality of jobs in the workflow.

A method for optimizing a workflow provided by a computing platform to a cloud computing system is described. Metrics for a job of the workflow run on the cloud computing system are provided. The job is run on the cloud computing system based on a schedule and a cloud computing infrastructure configuration. An update to the cloud computing infrastructure configuration is received. The update is based on the metrics. The cloud computing infrastructure configuration is automatically updated based on the update, thereby providing an updated cloud computing infrastructure configuration. A next scheduled run of the job on the cloud computing system is performed. The next scheduled run is based on the updated cloud computing infrastructure configuration.

The metrics may be provided in response to a completion of the job. In some embodiments, the metrics are gathered by a task. The task may run within the workflow or outside of the workflow. In some embodiments, the method includes repeating, for the next scheduled run, the providing the metrics, the receiving the update, the automatically updating, and the performing the next scheduled run. In some embodiments, the method includes repeating the providing the metrics and the receiving the update for each of a plurality of jobs in the workflow.

A system for optimizing a workflow provided by a computing platform to a cloud computing system is described. The system includes a receiver module configured to receive metrics of a job of the workflow run on the cloud computing system. The job is run on the cloud computing system based on a schedule and a cloud computing infrastructure configuration. The system includes an optimization module coupled with the receiver module. The optimization module generates an update to the cloud computing infrastructure configuration based on the metrics. The cloud computing infrastructure configuration is automatically updated based on the update, thereby providing an updated cloud computing infrastructure configuration. A next scheduled run of the job on the cloud computing system is based on the updated cloud computing infrastructure configuration. In some embodiments, the receiver module comprises a task within or outside of the workflow.

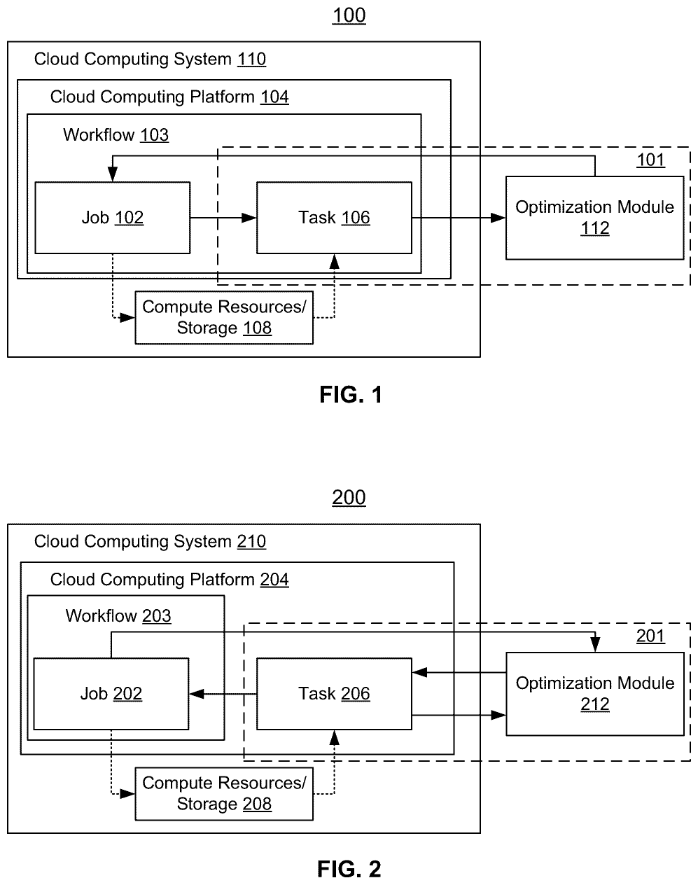

FIG. 1 is a block diagram illustrating an embodiment of system 101 for optimizing a cloud computing infrastructure configuration and environment 100 in which system 101 is used. For clarity, not all components are shown. In some embodiments, different and/or additional components may be present. In some embodiments, some components might be omitted. Environment 100 includes cloud computing system 110. System 101 includes task 106 and optimization module 112. Task 106 may be considered a receiver module or portion of a receiver module as it receives information from compute resources/storage 108.

Cloud computing system 110 may include one or more servers (or other computing systems), each of which includes multiple cores, memory resources, disk resources, networking resources, schedulers, and/or other computing components used in implementing tasks (e.g., processes performed) for executing workflows (e.g., applications). Though shown as a cloud system, in various embodiments, cloud computing system 110 is a physical compute system, a virtual private cloud (VPC), or any other appropriate computing system. Cloud computing system 110 may be on prem (e.g., under the control of and/or on the premises of) the entity generating workflow 102. In some embodiments, for example, cloud computing system 110 may include a single server (or other computing system) having multiple cores and associated memory and disk resources. Resources have associated costs, which may be based on resource type, resource specifications, resource availability, resource vendor, and/or other factors. Costs associated with resources for a job may not be accessible before the resources are used in a run of the job or may take a prohibitively long time to retrieve (e.g., in the case of a regularly recurring job, the time to retrieve the costs may be comparable to or greater than the time between consecutive runs of the job).

In the embodiment shown, cloud computing system 110 includes cloud computing platform 104 and compute resources/storage 108. Cloud computing system 110 may also include additional compute resources and/or additional storage. Cloud computing platform 104 receives information (e.g., from a user) used in implementing tasks and executing workflows within cloud computing system 110. Though shown as a platform for cloud computing system 110, in various embodiments, cloud computing platform 104 is a computing platform for a physical compute system, a virtual private cloud (VPC), or any other appropriate computing system. Cloud computing platform 104 may be on prem of the entity for which workflow 102 is generated. Similarly, system 101 may be on prem. In some embodiments, cloud computing platform 104 is a DATABRICKS® environment. The information may include the tasks and/or workflows, infrastructure configurations (e.g., allocation of compute resources/storage to the tasks/workflows), schedules of tasks, relationships between tasks, or any other appropriate information. Tasks are implemented and workflows are executed within cloud computing system 110 based on the information.

In the embodiment shown, cloud computing platform 104 includes workflow 103, containing job 102 and task 106. Workflow 103 is executed within cloud computing system 110 based on the information of cloud computing platform 104. Within workflow 103, a run of job 102 is performed using compute resources/storage 108. Event logs created by the run of job 102 are stored on compute resources/storage 108. Compute resources/storage 108 may also store other metrics (e.g., an infrastructure configuration associated with the run of job 102, a cost associated with the run of job 102, specifications of compute resources/storage 108, etc.). Task 106 is initiated after the completion of the run of job 102. In some embodiments, job 102 and/or workflow 103 are configured to initiate task 106 in response to the completion of the run of job 102. Task 106 gathers and transmits the event logs and/or the other metrics from compute resources/storage 108 to optimization module 112. Thus metrics may be received by optimization module 112 in response to the completion of the run of job 102.

Optimization module 112 generates an update to an infrastructure configuration associated with the run of job 102 based on the event logs and/or the other metrics. The infrastructure configuration is automatically updated based on the update generated by optimization module 112. A subsequent run (e.g., a next scheduled run) of job 102 is based on the updated infrastructure configuration. Thus, the subsequent run of job 102 may use compute resources/storage, and/or configurations of compute resources/storage, different from or in addition to compute resources/storage 108 shown in FIG. 1. In the embodiment shown, the update is sent directly to job 102 by optimization module 112. In various embodiments, the update may be sent to and/or applied by cloud computing system 110, cloud computing platform 104, workflow 103, job 102, task 106, and/or any other appropriate destination. The updated infrastructure configuration may be generated to optimize cost, runtime, latency, and/or any other appropriate aspect(s) of a subsequent run of job 102. In some embodiments, the updated infrastructure configuration may be based on multiple aspects of a subsequent run of job 102. For example, optimization module 112 may generate the updated infrastructure configuration to minimize the cost of a subsequent run of job 102 without exceeding a threshold runtime. Similarly, optimization module 112 may generate the updated infrastructure configuration to minimize the runtime of a subsequent run of job 102 without exceeding a threshold cost. Optimizing cost may include calculating an estimated cost of running job 102 using an updated infrastructure configuration. The estimated cost may be calculated based on the metrics and at least one known or estimated cost associated with the cloud computing system. In some embodiments, generating the update is performed in real time. Thus, time and accessibility issues associated with retrieving costs may be avoided. For the subsequent run, gathering of event logs and/or other metrics, and generating an update, may be repeated. The infrastructure configuration may thus be updated multiple times.

In some embodiments, job 102 is one of multiple jobs within workflow 103. The gathering of event logs and/or other metrics, and generating an update, may be repeated for other jobs within workflow 103. In some embodiments, workflow 103 is one of multiple workflows executed within cloud computing system 110. Another workflow of the multiple workflows may include another task comparable to task 106 (i.e., within system 101 and in communication with optimization module 112). The other task may gather and transmit event logs and/or other metrics, from compute resources/storage 108 and/or from any other appropriate compute resources and/or storage. Optimization module 112 may generate another update for the other workflow, and another infrastructure configuration may be automatically updated based on the other update.

Thus, using system 101, the configuration of cloud computing resources may be automatically updated based upon the performance of cloud computing system 110 in carrying out the tasks for job 102. For example, the initial configuration of cloud computing resources may be selected by a user (or another mechanism). Using the metrics (i.e. history) obtained from the run of job 102, optimization module 112 determines a new resource configuration in real time. For example, an optimized resource configuration may be determined by optimization module 112 before a subsequent run of job 102. The new configuration is automatically implemented on cloud computing system 110. On the next scheduled run of job 102, this new configuration of cloud computing resources is used. This process may be iteratively repeated for each subsequent run of job 102. Thus, performance of job 102 (e.g. latency and/or cost) may by automatically and dynamically updated without user intervention. Consequently, performance of cloud computing system 110 for workflow 103 may be improved. Further, for portions of environment 100 being on prem, the entity for which workflow 103 may be generated has greater control over environment 100. Consequently, security may also be improved.

FIG. 2 is a block diagram illustrating an embodiment of system 201 for optimizing a cloud computing infrastructure configuration and environment 200 in which system 201 is used. For clarity, not all components are shown. In some embodiments, different and/or additional components may be present. In some embodiments, some components might be omitted. Environment 200 includes cloud computing system 210. System 201 includes task 206 and optimization module 212. Task 206 may be considered a receiver module or portion of a receiver module as it receives information from compute resources/storage 208. Environment 200, system 201, cloud computing system 210, cloud computing platform 204, workflow 203, job 202, task 206, compute resources/storage 208, and optimization module 212 are analogous to environment 100, system 101, cloud computing system 110, cloud computing platform 104, workflow 103, job 102, task 106, compute resources/storage 108, and optimization module 112.

In the embodiment shown, cloud computing system 210 is analogous to cloud computing system 110 of FIG. 1. Cloud computing system 210 may include a variety of computing resources used in implementing tasks and executing workflows. Cloud computing system 210 includes cloud computing platform 204 and compute resources/storage 208. Cloud computing system 210 may also include additional compute resources and/or additional storage. Though shown as a cloud system, in various embodiments, cloud computing system 210 is a physical compute system, a virtual private cloud (VPC), or any other appropriate computing system. In such embodiments, cloud computing platform 204 is a computing platform for the appropriate computing system. Cloud computing system 210 and cloud computing system 204 may be on prem of the entity for which workflow 202 is generated. Similarly, system 201 may be on prem. Cloud computing platform 204 receives information (e.g., from a user) used in implementing tasks and executing workflows within cloud computing system 210. In some embodiments, cloud computing platform 204 is a DATABRICKS® environment. The information may include the tasks and/or workflows, infrastructure configurations (e.g., allocation of compute resources/storage to the tasks/workflows), schedules of tasks, relationships between tasks, or any other appropriate information. Tasks are implemented and workflows are executed within cloud computing system 210 based on the information.

In the embodiment shown, cloud computing platform 204 includes workflow 203, containing job 202. Workflow 203 is executed within cloud computing system 210 based on the information of cloud computing platform 204. Within workflow 203, a run of job 202 is performed using compute resources/storage 208. Event logs created by the run of job 202 are stored on compute resources/storage 208. Compute resources/storage 208 may also include other metrics (e.g., an infrastructure configuration associated with the run of job 202, a cost associated with the run of job 202, specifications of compute resources/storage 208, etc.).

Completion of the run of job 202 may be indicated to optimization module 212 by cloud computing system 210 and/or cloud computing platform 204. In some embodiments, the indicating the completion of the run is performed by a webhook. For example, in response to the completion of the run of job 202, job 202 may shut down the cluster on which job 202 ran. Cloud computing system 210 may send a webhook message to optimization module 212 that the run has completed. For example, job 202 may send the webhook message to optimization module 212. Other techniques may be used to indicate the completion of the run (e.g. a cloud monitoring service, an event handler, etc.). For example, optimization module 212 may subscribe to such a monitoring service of cloud computing 110. Optimization module 212 triggers task 206 to gather and transmit the event logs and/or the other metrics from compute resources/storage 208 to optimization module 212. Task 206 may gather and transmit additional information from cloud computing system 210. In some embodiments, task 206 runs asynchronously. For example, task 206 may be triggered after all runs of a set of jobs have completed. Task 206 may then gather and transmit event logs and/or other metrics from all runs of the set of jobs.

Optimization module 212 generates an update to an infrastructure configuration associated with the run of job 202 based on the event logs and/or the other metrics. The infrastructure configuration is automatically updated based on the update generated by optimization module 212. A subsequent run (e.g., a next scheduled run) of job 202 is based on the updated infrastructure configuration. Thus, the subsequent run of job 202 may use compute resources/storage, and/or configurations of compute resources/storage, other than compute resources/storage 208. In the embodiment shown, the update is sent to job 202 via task 206. In various embodiments, the update may be sent to and/or applied by cloud computing system 210, cloud computing platform 204, workflow 203, job 202, task 206, or any other appropriate destination. The updated infrastructure configuration may be generated to optimize cost, runtime, latency, or any other appropriate aspect(s) of a subsequent run of job 202. In some embodiments, the updated infrastructure configuration may be based on multiple aspects of a subsequent run of job 202. For example, optimization module 212 may generate the updated infrastructure configuration to minimize the cost of a subsequent run of job 202 without exceeding a threshold runtime. Optimizing cost may include calculating an estimated cost of running job 202 using an updated infrastructure configuration. The estimated cost may be calculated based on the metrics and at least one cost associated with the cloud computing system. In some embodiments, generating the update is performed in real time. Thus, time and accessibility issues associated with retrieving costs may be avoided. For the subsequent run, gathering of event logs and/or other metrics, and generating an update, may be repeated. The infrastructure configuration may thus be updated multiple times. Consequently, system 201 may share the benefits of system 101.

In some embodiments, job 202 is one of multiple jobs within workflow 203. The gathering of event logs and/or other metrics, and generating an update, may be repeated for other jobs within workflow 203. In some embodiments, workflow 203 is one of multiple workflows executed within cloud computing system 210. Task 206 may gather and transmit event logs and/or other metrics from jobs of the multiple workflows. Optimization module 212 may generate updates for the job(s) of each of the multiple workflows, and infrastructure configurations may be updated automatically based on the updates. Both task 206 and optimization module 212 may operate outside of the multiple workflows. Thus event logs and/or other metrics may be gathered, and updates may be generated, without the inclusion of additional tasks in the multiple workflows. Thus, in addition to the benefits of system 101, system 201 improves performance without (or with minimal) modification of the user's workflow. Accordingly, modification of the multiple workflows may be minimized, and stability and reliability of the multiple workflows may be improved.

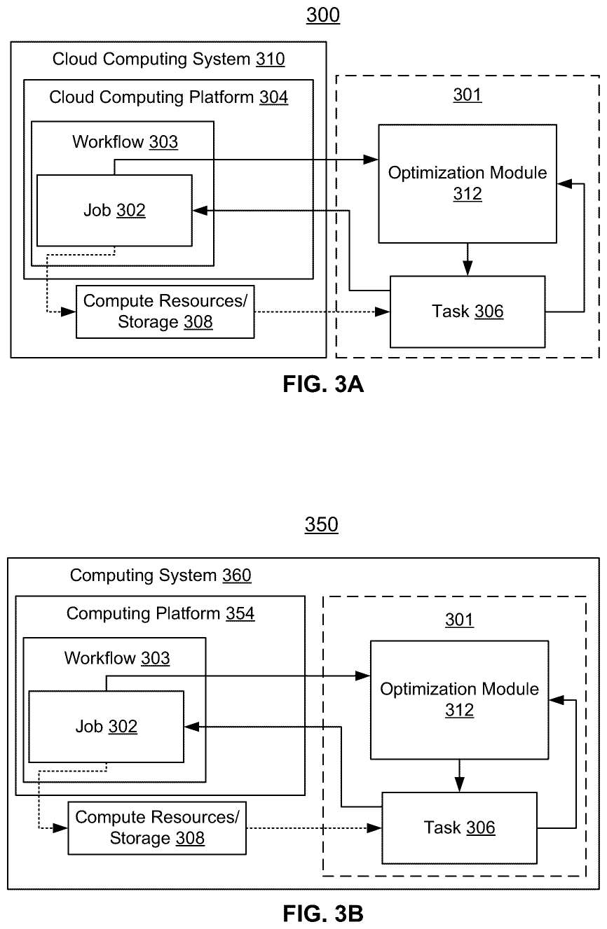

FIG. 3A is a block diagram illustrating an embodiment of system 301 for optimizing a cloud computing infrastructure configuration and environment 300 in which system 301 is used. For clarity, not all components are shown. In some embodiments, different and/or additional components may be present. In some embodiments, some components might be omitted. Environment 300 includes cloud computing system 310 and system 301. System 301 includes task 306 and optimization module 312. Environment 300, system 301, cloud computing system 310, cloud computing platform 304, workflow 303, job 302, task 306, compute resources/storage 308, and optimization module 312 are thus analogous to environment 100, system 101, cloud computing system 110, cloud computing platform 104, workflow 103, job 102, task 106, compute resources/storage 108, and optimization module 112. Task 306 may be considered a receiver module or portion of a receiver module as it receives information from compute resources/storage 308.

In the embodiment shown, cloud computing system 310 is analogous to cloud computing system 210 of FIG. 2. Cloud computing system 310 may include a variety of computing resources used in implementing tasks and executing workflows. Cloud computing system 310 includes cloud computing platform 304 and compute resources/storage 308. Cloud computing system 310 may also include additional compute resources and/or additional storage. Though shown as a cloud system, in various embodiments, cloud computing system 310 is a physical compute system, a virtual private cloud (VPC), or any other appropriate computing system. In such embodiments, cloud computing platform 304 is a computing platform for the appropriate computing system. Cloud computing system 310 and cloud computing platform 304 may be on prem of the entity for which workflow 302 is generated. Similarly, system 301 may be on prem. Cloud computing platform 304 receives information (e.g., from a user) used in implementing tasks and executing workflows within cloud computing system 310. In some embodiments, cloud computing platform 304 is a DATABRICKS® environment. The information may include the tasks and/or workflows, infrastructure configurations (e.g., allocation of compute resources/storage to the tasks/workflows), schedules of tasks, relationships between tasks, or any other appropriate information. Tasks are implemented and workflows are executed within cloud computing system 310 based on the information.

In the embodiment shown, cloud computing platform 304 includes workflow 303, containing job 302. Workflow 303 is executed within cloud computing system 310 based on the information of cloud computing platform 304. Within workflow 303, a run of job 302 is performed using compute resources/storage 308. Event logs created by the run of job 302 are stored on compute resources/storage 308. Compute resources/storage 308 may also include other metrics (e.g., an infrastructure configuration associated with the run of job 302, a cost associated with the run of job 302, specifications of compute resources/storage 308, etc.).

Completion of the run of job 302 may be indicated to optimization module 312 by cloud computing system 310 and/or cloud computing platform 304. In some embodiments, the indicating the completion of the run is performed by a webhook. For example, in response to the completion of the run of job 302, cloud computing system 310 may send a webhook message to optimization module 312 that the run has completed. Other techniques may be used to indicate the completion of the run (e.g. a cloud monitoring service, an event handler, etc.). Optimization module 312 triggers task 306 to gather and transmit the event logs and/or the other metrics from compute resources/storage 308 to optimization module 312. Task 306 may gather and transmit additional information from cloud computing system 310. In some embodiments, task 306 is triggered to run asynchronously. For example, task 306 may be triggered after all runs of a set of jobs have completed. Task 306 may then gather and transmit event logs and/or other metrics from the runs of the set of jobs. In some embodiments, techniques other than webhooks may be used to allow task 306 and optimization module 312 to hook into the start and completion of the run of job 302.

Optimization module 312 generates an update to an infrastructure configuration associated with the run of job 302 based on the event logs and/or the other metrics. The infrastructure configuration is automatically updated based on the update generated by optimization module 312. A subsequent run (e.g., a next scheduled run) of job 302 is based on the updated infrastructure configuration. Thus, the subsequent run of job 302 may use compute resources/storage, and/or configurations of compute resources/storage, other than compute resources/storage 308. In the embodiment shown, the update is sent to job 302 via task 306. In various embodiments, the update may be sent to and/or applied by cloud computing system 310, cloud computing platform 304, workflow 303, job 302, task 306, or any other appropriate destination. The updated infrastructure configuration may be generated to optimize cost, runtime, latency, or any other appropriate aspect(s) of a subsequent run of job 302. In some embodiments, the updated infrastructure configuration may be based on multiple aspects of a subsequent run of job 302. For example, optimization module 312 may generate the updated infrastructure configuration to minimize the cost of a subsequent run of job 302 without exceeding a threshold runtime. Optimizing cost may include calculating an estimated cost of running job 302 using an updated infrastructure configuration. The estimated cost may be calculated based on the metrics and at least one cost associated with cloud computing system 310. For example, the cost(s) associated with cloud computing system 310 may be based on estimates or previously known costs for resources and other aspects of cloud computing system 310. In some embodiments, generating the update is performed in real time (e.g. prior to a next scheduled run of job 302). Thus, time and accessibility issues associated with retrieving costs may be avoided. For the subsequent run, gathering of event logs and/or other metrics, and generating an update, may be repeated. The infrastructure configuration may thus be updated multiple times.

In some embodiments, job 302 is one of multiple jobs within workflow 303. The gathering of event logs and/or other metrics, and generating an update, may be repeated for other jobs within workflow 303. In some embodiments, workflow 303 is one of multiple workflows executed within cloud computing system 310. Task 306 may gather and transmit event logs and/or other metrics from jobs of the multiple workflows. Optimization module 312 may generate updates for the job(s) of each of the multiple workflows, and infrastructure configurations may be updated automatically based on the updates. Both task 306 and optimization module 312 may operate outside of cloud computing system 310. Thus event logs and/or other metrics may be gathered, and updates may be generated, without the inclusion of additional tasks within cloud computing system 310. Accordingly, modification of cloud computing system 210 may be minimized, and stability and reliability of cloud computing system 210 may be improved.

FIG. 3B is a block diagram illustrating another embodiment of system 301 and environment 350 in which system 301 is used. For clarity, not all components are shown. In some embodiments, different and/or additional components may be present. In some embodiments, some components might be omitted. Environment 350 includes computing system 360. In various embodiments computing system 360 is a physical computing system, a cloud computing system, a virtual private cloud (VPC), or any other appropriate system that may be on prem for the entity for which workflow 303 is generated. Thus computing system 360 is analogous to cloud computing system 310 of FIG. 3A. In the embodiment shown, computing system 360 is a physical compute system. Computing platform 354 receives information (e.g., from a user) used in implementing tasks and executing workflows within computing system 360. In some embodiments, computing platform 354 is a DATABRICKS® environment. The information may include the tasks and/or workflows, infrastructure configurations (e.g., allocation of compute resources/storage to the tasks/workflows), schedules of tasks, relationships between tasks, or any other appropriate information. Tasks are implemented and workflows are executed within computing system 360 based on the information. Thus computing platform 354 is analogous to cloud computing platform 304 of FIG. 3A. In environment 350, system 301 is run on computing system 360. Compute resources used to run system 301 may be allocated exclusively to system 301 or may be shared with other systems or processes. System 301 in environment 350 may share the benefits of system 301 in environment 300. In addition, environment 350 allows the entity for which workflow 303 is generated to control and provide security for environment 350.

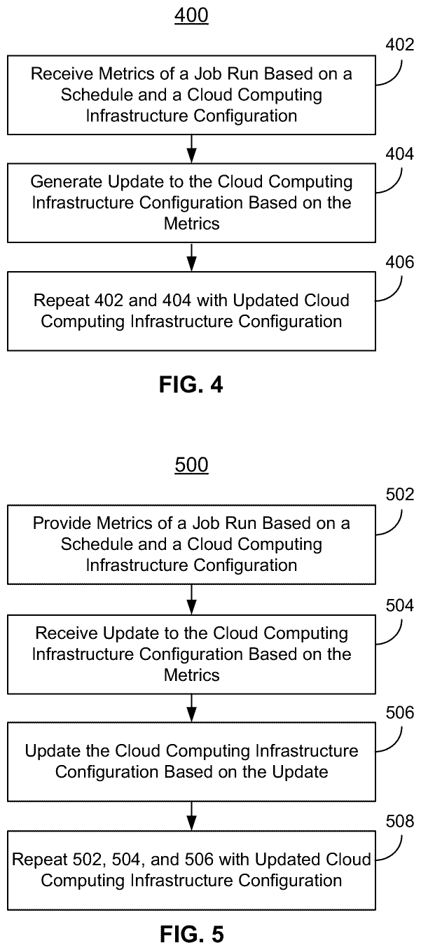

FIG. 4 is a flow diagram illustrating an embodiment of method 400 for optimizing a workflow provided by a cloud computing platform to a cloud computing system. Method 400 may be used in conjunction with system 301 of FIG. 3 (e.g., by optimization module 312). However, in other embodiments, method 400 may be utilized with other systems. Although certain processes are shown in a particular order for method 400, other processes and/or other orders may be utilized in other embodiments.

Metrics of a run of a job are received at 402. The job is run based on a schedule and a cloud computing infrastructure configuration. In various embodiments, the metrics include event logs, specifications of the computing platform, specifications of the cloud computing infrastructure, cost of the run of the job, estimated cost of the run of the job, runtime of the run of the job, estimated runtime of the run of the job, latency of the run of the job, estimated latency of the run of the job, accuracy of the run of a job, or any other appropriate metric. In some embodiments, the metrics are transmitted by a receiver module (e.g., task 306 of FIG. 3) that may have gathered the metrics of the run of the job (e.g., from compute resources/storage 308 of FIG. 3).

An update to the cloud computing infrastructure configuration is generated at 404. The update is generated based on the metrics received at 402. The update may be generated to optimize at least one of job cost, job runtime, or job latency. In some embodiments, job cost is based on an estimated cost of running the job on the cloud computing system after applying the update. The estimated cost may be calculated based on the metrics and at least one cost associated with the cloud computing system. The cost(s) associated with the cloud computing system may be a cost per gigabyte of storage, a cost per hour of use, a cost per request, a cost per compute unit, or any other appropriate cost. The cloud computing infrastructure configuration is automatically updated based on the update (e.g., by the cloud computing system, the cloud computing platform, etc.), thus providing an updated cloud computing infrastructure configuration.

402 and 404 are repeated at 406 with the updated cloud computing infrastructure configuration (i.e., at 402, the run of the job is based on the updated cloud computing infrastructure configuration). The cloud computing infrastructure configuration may thus be updated multiple times. Method 400 may also be repeated for multiple jobs in a workflow, and/or for multiple workflows in the cloud computing system.

FIG. 5 is a flow diagram illustrating an embodiment of method 500 for optimizing a workflow provided by a cloud computing platform to a cloud computing system. Method 500 may be used in conjunction with system 301 of FIG. 3 (e.g., by a receiver module such as task 306). However, in other embodiments, method 500 may be utilized with other systems. Although certain processes are shown in a particular order for method 500, other processes and/or other orders may be utilized in other embodiments.

Metrics of a run of a job are provided at 502. The job is run based on a schedule and a cloud computing infrastructure configuration. The metrics may be gathered from the cloud computing system (e.g., from compute resources/storage 308 of FIG. 3). In various embodiments, the metrics include event logs, specifications of the computing platform, specifications of the cloud computing infrastructure, cost of the run of the job, estimated cost of the run of the job, runtime of the run of the job, estimated runtime of the run of the job, latency of the run of the job, estimated latency of the run of the job, accuracy of the run of a job, or any other appropriate metric. In some embodiments, the metrics are provided to an optimization module (e.g., optimization module 312 of FIG. 3).

An update to the cloud computing infrastructure configuration is received at 504. The update is based on the metrics provided at 502. The update may be generated to optimize at least one of job cost, job runtime, or job latency. In some embodiments, job cost is based on an estimated cost of running the job on the cloud computing system after applying the update. The estimated cost may be calculated based on the metrics and at least one cost associated with the cloud computing system. The cost(s) associated with the cloud computing system may be a cost per gigabyte of storage, a cost per hour of use, a cost per request, a cost per compute unit, or any other appropriate cost.

The cloud computing infrastructure configuration is updated at 506 based on the update. Thus an updated cloud computing infrastructure configuration is provided. In some embodiments, the update may be sent to and automatically applied by the cloud computing system, the cloud computing platform, or another appropriate destination.

502, 504, and 506 are repeated at 508 based on the updated cloud computing infrastructure configuration. (i.e., at 502, the run of the job is based on the updated cloud computing infrastructure configuration). The cloud computing infrastructure configuration may thus be updated multiple times. Method 500 may also be repeated for multiple jobs in a workflow, and/or for multiple workflows in the cloud computing system.

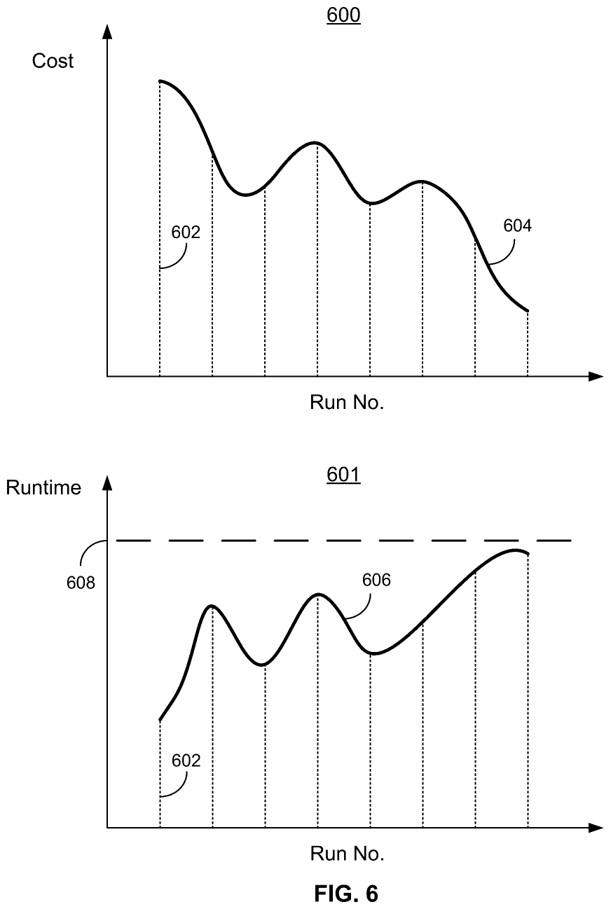

FIG. 6 depicts a graph 600 of an embodiment of estimated cost and graph 601 of an embodiment of runtime over multiple runs of a job (e.g., job 102 of FIG. 1). Graph 600 and graph 601 are for explanatory purposes only and are not intended to represent a particular workflow. An infrastructure configuration associated with the job is updated between each of the multiple runs of the job (e.g., by optimization module 112 of FIG. 1). In various embodiments, the updates are generated to optimize job cost, job runtime, job latency, or any other appropriate aspect(s) of the job. The updated infrastructure configuration may be based on multiple aspects of the job. In the embodiment shown, the updates are generated to minimize cost of the job without exceeding a threshold runtime.

Cost, represented in graph 600 by line 604, can be seen to decrease over the multiple runs of the job. Each run of the multiple runs is represented in graph 600 and in graph 601 by dotted lines 602 (only the first of which, corresponding to the first run of the multiple runs, is labeled). For a particular run, cost may increase compared to a preceding run. However, over the multiple runs, cost can be seen in graph 600 to approach a global minimum.

Runtime, represented in graph 601 by line 606, can be seen never to exceed the threshold runtime, represented by dashed line 608. For a particular run, runtime may increase compared to a preceding run, and over the multiple runs, runtime can be seen in graph 601 to increase. However, none of the multiple runs exceed the threshold runtime. Thus, performance of a cloud computing system in running scheduled jobs may be dynamically improved without user intervention.

Although the foregoing embodiments have been described in some detail for purposes of clarity of understanding, the invention is not limited to the details provided. There are many alternative ways of implementing the invention. The disclosed embodiments are illustrative and not restrictive.

1. A method for optimizing a workflow provided by a computing platform to a cloud computing system, comprising:
receiving metrics for a job of the workflow run on the cloud computing system, the job being run on the cloud computing system based on a schedule and a cloud computing infrastructure configuration;
generating an update to the cloud computing infrastructure configuration based on the metrics;
wherein the cloud computing infrastructure configuration is automatically updated based on the update, thereby providing an updated cloud computing infrastructure configuration; and
wherein a next scheduled run of the job on the cloud computing system is based on the updated cloud computing infrastructure configuration.

2. The method of claim 1, wherein the generating the update is performed in real time.

3. The method of claim 1, wherein the metrics are received in response to a completion of the job.

4. The method of claim 3, wherein the completion of the job is indicated by the cloud computing system.

5. The method of claim 1, wherein the metrics are gathered by a task.

6. The method of claim 5, wherein the task runs within the workflow.

7. The method of claim 5, wherein the task runs outside of the workflow.

8. The method of claim 1, wherein the update is generated to optimize at least one of a job cost, a job runtime, or a job latency.

9. The method of claim 8, wherein the job cost is based on an estimated cost of running the job on the cloud computing system after applying the update.

10. The method of claim 9, wherein the estimated cost is calculated based on the metrics and at least one cost associated with the cloud computing system.

11. The method of claim 1, wherein the metrics include one or more of the following: event logs, specifications of the computing platform, specifications of the cloud computing infrastructure, cost of a run of the job, estimated cost of a run of the job, runtime of a run of the job, estimated runtime of a run of the job, estimated latency of a run of the job, or latency of a run of the job.

12. The method of claim 1, further comprising repeating, for the next scheduled run, receiving the metrics and generating the update.

13. The method of claim 1, wherein receiving the metrics and generating the update are repeated for each of a plurality of jobs of the workflow.

14. A method for optimizing a workflow provided by a computing platform to a cloud computing system, comprising:
providing metrics for a job of the workflow run on the cloud computing system, the job being run on the cloud computing system based on a schedule and a cloud computing infrastructure configuration;
receiving an update to the cloud computing infrastructure configuration, the update being based on the metrics; and
automatically updating the cloud computing infrastructure configuration based on the update, thereby providing an updated cloud computing infrastructure configuration;
performing a next scheduled run of the job on the cloud computing system, the next scheduled run being based on the updated cloud computing infrastructure configuration.

15. The method of claim 14, wherein the metrics are provided in response to a completion of the job.

16. The method of claim 14, wherein the metrics are gathered by a task within or outside of the workflow.

17. The method of claim 14, further comprising repeating, for the next scheduled run, providing the metrics and receiving the update.

18. The method of claim 14, wherein providing the metrics and receiving the update are repeated for each of a plurality of jobs of the workflow.

19. A system for optimizing a workflow provided by a computing platform to a cloud computing system, the system comprising:
a receiver module configured to receive metrics for a job of the workflow run on the cloud computing system, the job being run on the cloud computing system based on a schedule and a cloud computing infrastructure configuration;
an optimization module coupled with the receiver module, the optimization module configured to generate an update to the cloud computing infrastructure configuration based on the metrics, wherein the cloud computing infrastructure configuration is automatically updated based on the update, thereby providing an updated cloud computing infrastructure configuration, and wherein a next scheduled run of the job on the cloud computing system is based on the updated cloud computing infrastructure configuration.

20. The system of claim 19, wherein the receiver module comprises a task within or outside of the workflow.
